(19) United States
(12) Patent Application Publication
(10) Pub. No.: US 2008/0217396 A1
(43) Pub. Date: Sep. 11, 2008

(54) DEVICE AND METHOD FOR CONDUCTING SECURE ECONOMIC TRANSACTIONS

(75) Inventor: Adam Boalt, West Palm Beach, FL (US)

Correspondence Address: MAYBACK & HOFFMAN, P.A., 5722 S. FLAMINGO ROAD #232, FORT LAUDERDALE, FL, 33330, US

(73) Assignee: SecureCard Technologies, Inc., West Palm Beach, FL (US)

(21) Appl. No.: 11/682,659

(22) Filed: Mar. 6, 2007

(51) Int. Cl. G06F 7/00

(52) U.S. Cl. 235/380

(57) ABSTRACT

A secure economic transaction device includes a memory for storing user account information, a temporary code generator coupled to the memory and operable to generate a code based upon the user account information that is valid for only a finite amount of time, and a wireless transmitter operable to wirelessly transmit the user account information and the code.

### CROSS-REFERENCE TO RELATED APPLICATIONS

This patent application is related to U.S. patent application Ser. No. 11/256,441, Attorney Docket Number 1702-P0001, filed on Oct. 24, 2005, the entire disclosure of which is herein incorporated by reference.

### FIELD OF THE INVENTION

The present invention relates generally to wireless credit card operations, and more particularly relates to wireless credit or debit cards that have, and wirelessly transmit, account access codes that are valid for a limited time.

### BACKGROUND OF THE INVENTION

Credit cards, charge cards, and debit cards are in wide use and are well known to the general public. With a credit card, an issuer loans money to a credit-card holder by sending payment to a retailer for items a card holder purchases. The issuer then charges the card holder interest on the purchase price until the card balance is paid back to the issuer. A debit card, on the other hand, is linked to the card holder's account and removes money from the account after every transaction. A charge card is different from a credit card, although the names are often interchanged. A charge card may require the balance to be paid in full each month. Most cards—credit, debit, charge, or otherwise—are the same shape and size, which is generally a thin rectangular shape, as specified by the ISO 7810 standard. These cards all have account numbers that allow the issuer to determine the holder matching the purchase. The term “credit card,” will be used generically herein, and is not necessarily meant to refer only to a credit card, but can also include charge cards, debit cards, and other types of cards that provide an identification number for making a purchase as well.

Electronic verification systems allow merchants to verify that the card is valid and that the credit card holder has sufficient credit to cover the purchase. Current systems are capable of making this verification within just a few seconds at the time of purchase. The verification is performed using a credit card payment terminal or Point of Sale (POS) system with a communications link to an account-verifying entity.

Data from the card has traditionally been obtained by swiping a magnetic stripe located on the back face of the card across a reader on the payment terminal. Alternatively, an account number stamped on the card can be manually entered by the merchant. Data on the card includes the holder's account number, along with an expiration date, and sometimes an additional verification number stamped on the card separate from the account number. Lately, other methods of transferring card information have been developed and implemented, such as smart card technology that uses embedded integrated circuits.

Once a card is stolen, it can be used relatively easily at any POS system until the holder becomes aware of the missing card and reports it to the issuer, who can then halt all transactions under that account number. Therefore, credit card theft is a significant problem for the card holder, who is typically liable for at least the first $50 of unauthorized charges placed on a stolen card, and even more so for the card issuer, who is left with responsible for the remainder of the balance charged by the thief.

Recently, a number of card manufacturers have begun placing wireless transmitters on credit cards in an effort to make purchases even easier for both the merchant and the card holder. By utilizing a wireless transmitter, a holder's account number is instantly communicated to a receiver in the POS system without the card holder ever having to present the physical card to the merchant. The wireless transmitter and a wireless receiver replaces the magnetic stripe and magnetic stripe reader. However, because the card is transmitting, those in close proximity of the card can easily intercept the private account information. This presents a significant security risk to the card holder, card issuer, and merchant.

Therefore a need exists to overcome the problems with the prior art as discussed above.

### SUMMARY OF THE INVENTION

Briefly, in accordance with the present invention, disclosed is a secure economic transaction device that includes a memory for storing user account information, a temporary code generator coupled to the memory and operable to generate a code based upon the user account information that is valid for only a finite amount of time, and a wireless transmitter operable to wirelessly transmit the user account information and the code.

In accordance with another feature, an embodiment of the present invention includes a medium for supporting the memory, the temporary code generator, and the wireless transmitter, wherein the medium is substantially the size and shape of a credit card.

In accordance with a further feature of the present invention, the temporary code generator is integrated within the medium.

In accordance with a further feature of the present invention, the code is based on a time of day.

In accordance with the present invention, a method for conducting a secure economic transaction is also disclosed, where the method includes generating, with a code generator integrated within a credit-card sized medium, a code based upon a user account number that is valid at a remote account verifying entity for only a finite amount of time, wirelessly transmitting the user account number from the medium to a payment terminal, and wirelessly transmitting the code from the medium to the payment terminal.

In accordance with another feature, an embodiment of the present invention includes also includes the steps of receiving a time from a clock, and incorporating the time into a temporary-number-generating algorithm.

In accordance with yet another feature, an embodiment of the present invention includes monitoring an elapsed time of a timer and generating a second temporary code after the elapsed time exceeds a maximum value.

In accordance with a further feature of the present invention, the temporary code is based upon a time of day.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating a front face of one embodiment of a wirelessly transmitting secure economic transaction device in accordance with the present invention.

FIG. 2 is a diagram illustrating a back face of the wirelessly transmitting secure economic transaction device of FIG. 1 in accordance with an embodiment of the present invention.

FIG. 3 is a schematic block diagram illustrating internal circuitry of the wirelessly transmitting secure economic transaction device of FIGS. 1 and 2 in accordance with one embodiment of the present invention.

FIG. 4 is a flow diagram of a secure economic transaction using a wirelessly transmitting temporary code generating device in accordance with an embodiment of the present invention.

FIG. 5 is a perspective view of a point of sale device wirelessly receiving account information and a temporary access code from a secure economic transaction device in accordance with an embodiment of the present invention.

FIG. 6 is a process flow diagram of a temporary number generation and verification process in accordance with an embodiment of the present invention.

FIG. 7 is a process flow diagram of a temporary number generation and verification process in accordance with an embodiment of the present invention.

FIG. 8 is a diagram illustrating a front face of one embodiment of a wirelessly transmitting secure smart card in accordance with the present invention.

FIG. 9 is a high level block diagram illustrating a detailed view of a computing system, according to an embodiment of the present invention

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to an embodiment, overcomes problems with the prior art by providing a secure economic transaction device in the form of a wirelessly account-information-transmitting card with an account-information generator that is capable of generating information that is valid only for a pre-determined amount of time. Unauthorized card use is thereby thwarted because a third party that is able to intercept the account information will not have enough time to use the information before at least a portion of the intercepted account number expires.

Described now is an exemplary hardware platform for use with embodiments of the present invention.

Credit Card

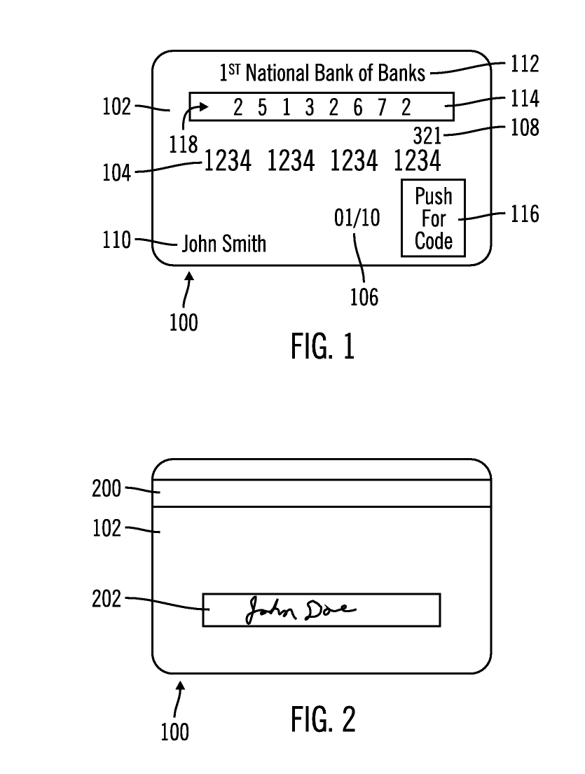

Referring now to FIG. 1, an exemplary credit card 100 is shown. As stated above, the term “credit card,” is used generically herein, and is not necessarily meant to refer only to a true credit card, but can include charge cards, debit cards, smart cards, microprocessor cards, and other identification number bearing cards of the same or different dimensions. FIG. 1 shows the front face of the credit card 100. In one embodiment, the card 100 is made of a medium 102, which can be, for example, plastic or other type of synthetic, and supports printed or raised characters, such as a visible account number 104, expiration date 106, authorization number 108, and name 110 of the cardholder. In addition, the card can include graphics 112 that identify the card issuer or an institution to which the card is associated.

An account number 104 is created and used by an issuing institution, such as a bank, to uniquely identify the card holder and the card holder's account. Generally, each issuer type is also identified by this number. For instance, account numbers issued by American Express are 15 digits long and account numbers issued by Visa and MasterCard are 16 digits long. In addition, account number formats are able to vary between issuing institutions.

In order to authorize a card's use, a merchant receives account information, such as the account number, so they can transmit it to the credit card issuer or some other credit verifying entity for verification of the account. This can be accomplished in several ways utilizing embodiments of the present invention, including traditional methods. A first traditional way is for the merchant to manually enter the account numbers digit by digit into the POS system. This can be accomplished by reading the visible number 104 on the front face of the card and typing them into a keypad on the payment terminal. A second traditional method to receive the account information is by swiping a magnet strip, described below, on the card across a magnetic strip reader. Both of these first two methods are well known in the art.

FIG. 2 shows the back side of the card 100, which includes a magnetic strip 200 attached to or integrated into the body 102. The magnetic strip 200 is encoded with the account number 104 shown on the front face or some other code that is associated with the user's account number. The POS system is provided with a magnetic strip reader that is used to capture the account number and transmit it to the credit card issuer for verification of the account. In addition to the two traditional methods of manually entering numbers and swiping the magnetic strip 200 on the card, as just described, embodiments of the present invention also provide further methods of communicating account information to a merchant that provide greater convenience and security than any method currently known in the art. Typically, the back side of credit cards has a signature box 202. When a card is first received, the holder signs his or her name in the signature box 202. During a transaction, a merchant can compare the signature of the person completing the transaction to the signature in the signature box 202. This comparison adds a layer of security to help ensure that the person completing the transaction is actually the authorized card holder.

Wireless Transmitter

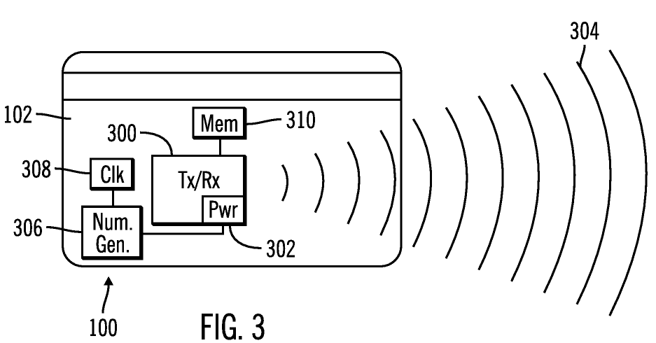

FIG. 3 shows the card 100 of FIGS. 1 and 2 with a wireless account information transmitting device 300 integrated into the body 102. In some embodiments of the present invention, device 300 is used as a receiving device as well. In one embodiment, the transmitter is a Radio Frequency Identification (RFID) device 300. Radio Frequency Identification (RFID) is a well-known automatic identification method, relying on storing and remotely retrieving data via the RFID transponders 300. In this application, the data is a credit card holder's account information and is stored in a memory 310 provided on the card 100.

The RFID device 300 used in embodiments of the present invention can be active or passive. Passive RFID devices can operate without an internal power supply. Minute electrical currents induced in the RFID antenna by the incoming RF signal provides just enough power for a circuit 306 in the device to power up and transmit a response. A typical circuit for use in this environment is a CMOS chip integrated into the card 100. Most passive RFID devices signal by backscattering the carrier signal from the reader. This means that the antenna is able to collect power from the incoming signal and also transmit the outbound backscatter signal.

The RFID device 300 can also be an active device, which has its own internal power source 302 which is used to power any integrated circuits that generate an outgoing radio frequency signal 304. In one embodiment, the power source 302 is a lithium polymer battery that is embedded in the credit card medium 102. Lithium polymer batteries are advantageous for this application because they are ultra-thin (about 0.37 mm thick), flexible, environmentally friendly, and safe for consumer use. The invention, however, is not limited to any particular form of power source.

In one embodiment, the active RFID device 300 has a practical communication range of only about 1 foot or less. This short range helps limit the number of persons that are able to receive, i.e., intercept, the credit card information to those that are in the very near vicinity. However, the present invention is not limited to any particular range and can, therefore, transmit at distances less than or greater than 1 foot.

The merchant is provided with a POS system that is able to wirelessly receive and interpret information from the card 100. The POS system will then treat the wirelessly received information as it would information obtained by swiping the card 100 across a magnetic strip reader as is well known in the art.

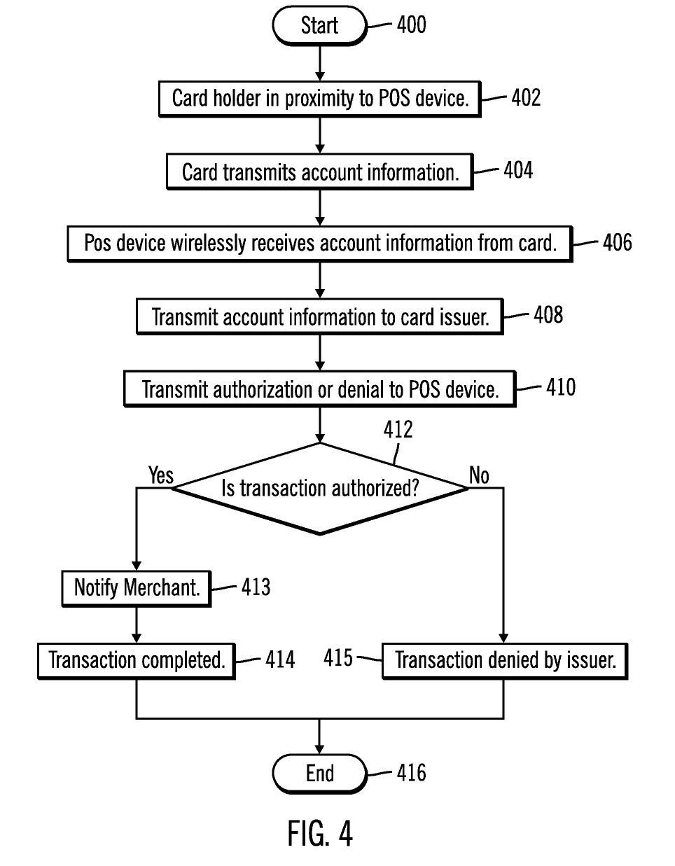

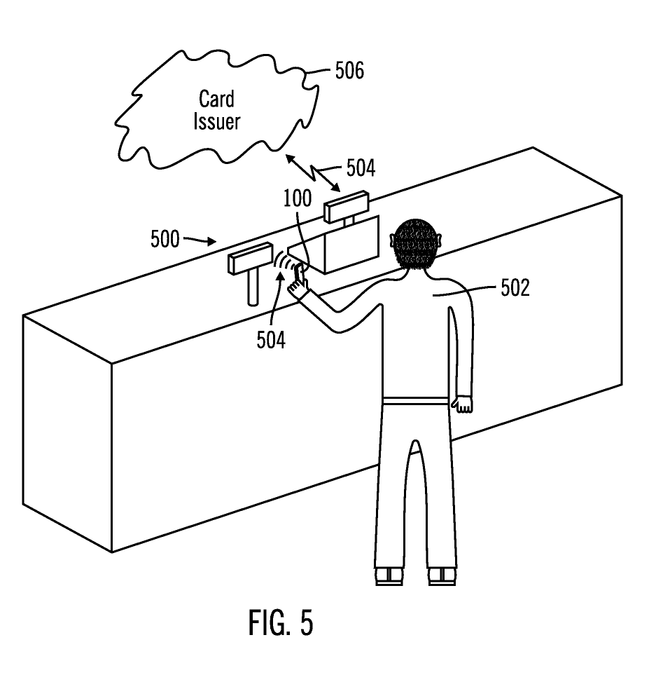

Transmitting and POS receiving steps of an embodiment of the inventive credit card will now be described with reference to FIGS. 4 and 5. FIG. 4 shows the process flow and FIG. 5 illustrates a card communication arrangement according to one embodiment of the present invention. The flow begins at step 400 and moves directly to step 402 where a card holder 502 in physical possession of a card 100 comes within a defined proximity to a POS terminal device 500, shown in FIG. 5. The proximity is preferably a small distance, e.g. a foot or less. In step 404 the card 100 wirelessly transmits account information 504 into space. The card transmission can be constant or can be stimulated by the user 502 or by a request from the POS device 500 that is received by, and responded to by, the card 100. In step 406, the account information 504 is wirelessly received by the terminal device 500. The account information 504 is then transmitted, in step 408, to an account verifying entity 506, which can be the card issuer or any agent or extension thereof, for verification that that account number is valid and that the transaction is authorized by the issuer of the card. This transmission can be wired, such as via the internet, phone line, or any other network, or may be wireless.

In step 410, a response in the form of an authorization or denial for the transaction is communicated back from the issuer 506 to the POS device 500. The communication from the issuer 506 back to the POS device 500 does not necessarily have to be along the same communication infrastructure as the original communication from the POS device 500 to the issuer 506. In some embodiments, only a denial communication will be sent back and the POS device will automatically authorize the transaction upon expiration of a length of time. In other embodiments, only an approval of authorization will be communicated back and the POS device will automatically decline or deny the transaction upon expiration of a length of time.

If the transaction is authorized, as determined at step 412, which can be accomplished through any practical means, the merchant is notified at step 413 and the transaction is completed in step 414. The process then ends at step 416. Alternatively, if the transaction is denied by the issuer 506, as determined at step 412, which can be accomplished through any practical means, the transaction is denied at step 415 and the process moves directly to step 416, where the process ends.

Unfortunately, because the wireless account information transmitting device 300 broadcasts in a substantially omni-directional pattern, anyone around the card with a reception device similar to merchant POS device 500, is able to intercept or otherwise receive the card holder's account number and use it for later unauthorized transactions. However, embodiments of the present invention provide a further feature that advantageously disables this ability of making fraudulent unauthorized transactions.

Temporary Number Generation

Returning now back to FIG. 1, the embodiment of the inventive card 100 is provided with a display 114. The display 114, in one embodiment, is a liquid crystal display (LCD), which is well known to those of average skill in the art. LCDs are thin, flat display devices made up of any number of color or monochrome pixels arrayed in front of a light source or reflector. LCDs have very low power requirements, and are therefore well suited for use in battery-powered electronic devices, such as the inventive card 100. The LCD display 114 can be made of materials such as organic thin-film transistors, electrophoretic plasma, organic light emitting diodes, and others. The invention, however, is not limited to any particular type of display.

The numbers 118 shown on and by the display 114 are generated by number generation circuitry 306 shown in FIG. 3. The number generation circuitry 306 includes a clock 308. The circuitry 306, in one embodiment, is able to produce an access number 118 or code that is time of day based. That is to say, the number generation circuitry 306 uses the current time of day, or simply a time value, provided by the clock 308, to generate a number 118. The number 118 is a valid number for authorizing a transaction linked to the user's account, but that is only valid for a finite amount of time. The access number or code 118 can be made of numbers, characters, symbols, or a combination thereof. The number generation circuitry 306 of the present invention can be realized in hardware, software, or a combination of hardware and software. A typical combination of hardware and software could be a general microprocessor with a computer program that, when executed, carries out the number generation methods described herein. Access number generation is described in co-pending U.S. patent application Ser. No. 11/256,441, filed on Oct. 24, 2005, the entire disclosure of which is hereby incorporated herein by reference. Upon expiration of the finite amount of time, a new number 118 is generated.

In one embodiment, the access number 118 is also generated at the location of the account-verifying entity 506, which includes the card issuer itself or some other appropriate account authorizing entity that is remote from the card 100. The access number 118 is transmitted to the account verifying entity 506 along with the card's account number 104. When the access number 118 is generated by the card 100 and transmitted to the account-verifying entity 506, the account-verifying entity 506 can look up the account number 104 and then compare the access number 118 to its generated access number to determine authorization.

In one embodiment of the present invention, the access number 118 is generated through use of one or more symmetric-key algorithms. Symmetric-key algorithms are a class of algorithms for cryptography that use trivially related cryptographic keys for both decryption and encryption. The encryption key is trivially related to the decryption key, in that they may be identical or there is a simple transform to go between the two keys. The keys, in practice, represent a shared secret between two or more parties that can be used to maintain a private information link. In this case, the card holder and the card issuer are the two parties sharing the secret, which is the user's account information. The invention, however, is not limited to any particular method or algorithm for generating the access number 118 or comparison, validation, or authentication of numbers. What is necessary is that the verifying entity is able to decode or otherwise understand the access number generated by the card 100 and verify the account to which the card is associated.

Because the authorization entity 506 and the card 100 are both using a time-of-day-based algorithm to generate the access number 118, both the account authorizing entity 506 and the card 100 are able to be synchronized by using synthesized time-of-day clocks. Therefore, the account authorizing entity 506 will be able to validate any unexpired access numbers 118. This validation can be through the use of any known or future developed validation methods. After the finite length of time, a new access number 118 must be generated and transmitted to the card issuer 506 or else the transactions will be denied.

The finite amount of time that the code is valid can be configured by various components to vary from 1 second to infinity; however, a practical time of validity is on the magnitude of about 60 seconds. The amount of time that the code is valid should be long enough for a merchant to receive the code, transmit it to an account verifying entity, and allow the account verifying entity to confirm that the code is valid. However, the length of time that the code is valid should be limited so that a code intercepting party will not have sufficient time to also forward a transaction with the same valid access number 118 to the account verifying entity.

In one embodiment, the access number 118, after being received by the verifying entity, is discarded from a list of authorizable codes. In this way, each access code is also only valid for a single transaction. Therefore, even if a thief were able to intercept the code number 118 and quickly submit a transaction, the transaction would be denied if the card holder submitted a transaction first.

In some instances, there may be a relatively long delay (e.g. several minutes) between the time the temporary access number 118 is generated and the time it is received by the verifying entity 506. In this situation, the transaction will be denied due to the number being expired. To compensate for this scenario, embodiments of the present invention monitor an elapsed time of the timer 308 and automatically generate a second temporary access code after the elapsed time exceeds a maximum value, for example, 60 seconds. A new access code 504 is then sent to the transaction device 500, which then submits the new access code to the verifying entity 506 along with the account number 104.

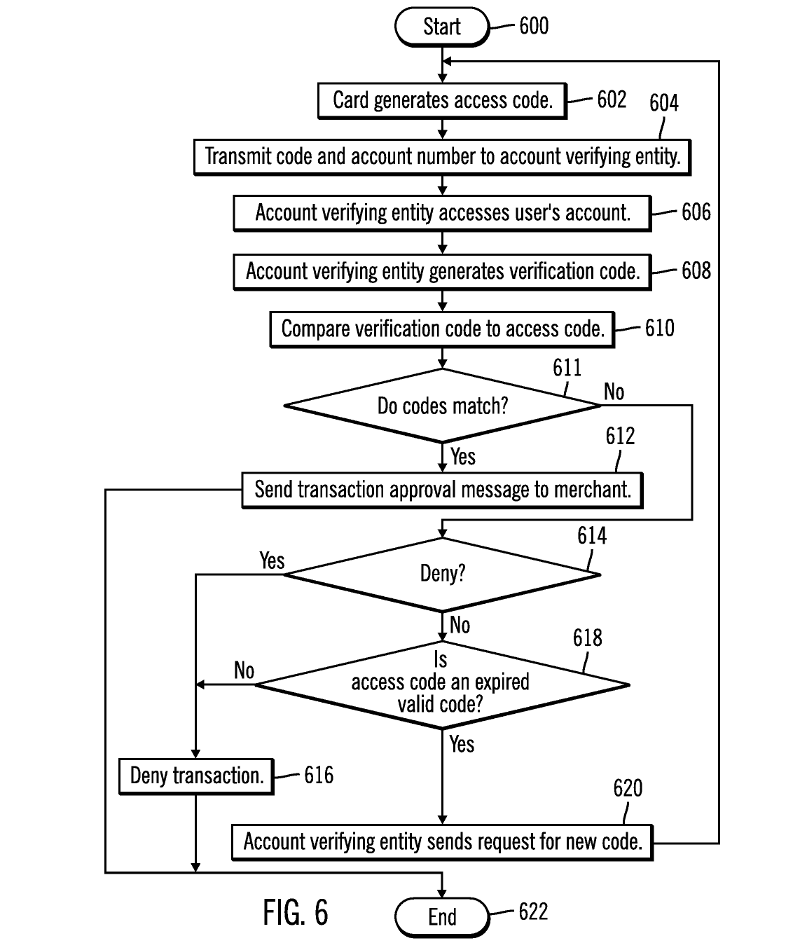

FIG. 6 shows a flow diagram of the temporary number generation and verification process according to an embodiment of the present invention. The flow begins at step 600 and moves directly to step 602 where a card 100 generates an access number 118. The code 118 is generated by an algorithm that uses the clock 308. The code 118, along with the user's account number 104 is then transmitted to an account verifying entity 506 in step 604. The account verifying entity 506 uses the account number 104, in step 606, to access the user's account in a database of accounts. The account verifying entity 506 then accesses a clock and generates a verification code in step 608. This verification code can be generated by using a standard algorithm common to all account holders or can use a key unique to a particular account holder to generate a verification code. In step 610, the account verifying entity 506 compares the verification code to the access code 118. A determination is made in step 611 as to whether the codes match. If the codes do match, the account verifying entity 506 transmits transaction approval message to the merchant requesting the transaction in step 612 and the process ends at step 622. However, if the codes do not match, the account verifying entity 506 will determine, in step 614 whether it wants to deny the transaction, step 616, or proceed to determine if the access code 118 is a valid code, but otherwise expired due to too much time passing between the time the code was generated and the time the account verifying entity 506 received the code. If the account verifying entity 506 chooses to determine if the code 118 is valid but simply expired, in step 618 the account verifying entity 506 takes the number apart, e.g. by using the secret key to reverse the algorithm that created the number at the number generation circuitry 306. If the number is valid, the account verifying entity 506 sends a message to the merchant machine 500 requesting a new code 118 in step 620. The flow then moves back up to step 602. If the number 118 is determined in step 618 not to be valid, the flow moves to step 616 and denies the transaction. The flow ends at step 622.

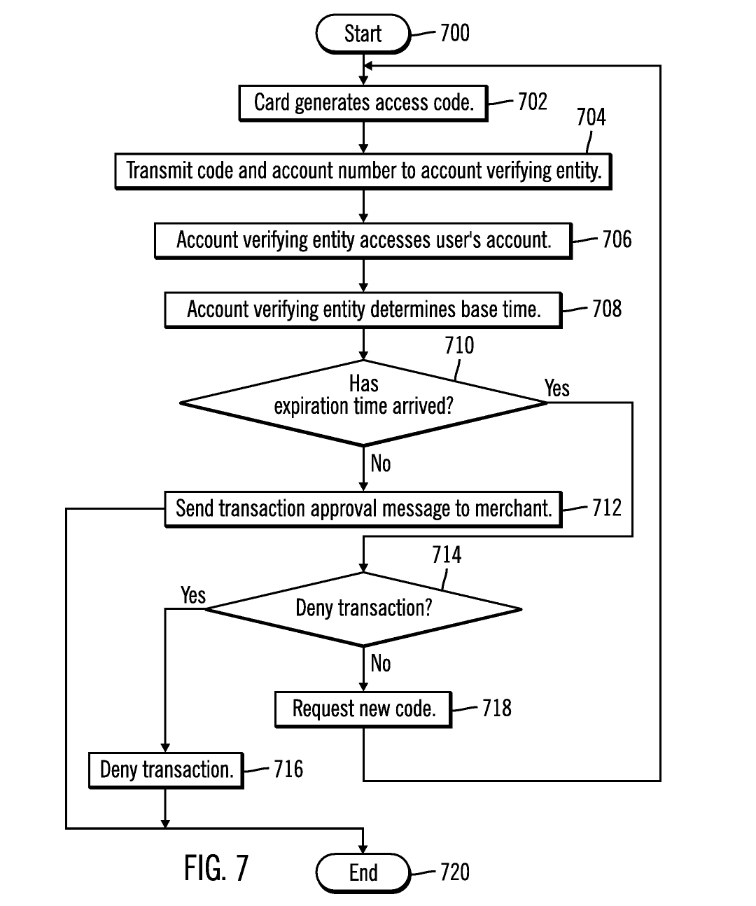

FIG. 7 shows a process flow of yet another embodiment of the present invention. The flow begins at step 700 and moves directly to step 702 where a card 100 generates an access code 118. The code 118 is generated by an algorithm that uses the clock 308. The code 118, along with the user's account number 104 is then transmitted to an account verifying entity 506 in step 704. The account verifying entity 506 uses the account number 104, in step 706, to access the user's account in a database of accounts. The account verifying entity 506 then, in step 708, reverses the algorithm that was used to generate the code 118 in an effort to determine the time that was used to form the code. Once the base time is determined, the account verifying entity 506 checks, in step 710, to see whether an expiration time has passed that now renders the code 118 invalid.

If the expiration time has not passed, the account verifying entity 506 transmits transaction approval message to the merchant requesting the transaction in step 712 and the process ends at step 720. However, if the time has expired, the account verifying entity 506 will determine, in step 714 whether it wants to deny the transaction, step 716, or send a message to the merchant machine 500 requesting a new code 118 in step 718. If a request for a new code is sent, the flow moves back up to step 702. The flow ends at step 720.

To conserve battery life, a button 116, shown in FIG. 1, can be provided that causes the temporary number generator 306 to generate a number and display it on the display 114 only after the button 116 is depressed. The display will only display the number when the button 116 is pushed and for a short time thereafter. Leaving the display 114 powered down and only causing the processing circuitry 306 to execute instructions at discrete times and for short periods greatly extends battery 302 life. It should be noted, however, that the display 114 is not necessary for wirelessly transmitting the user's account number and access code. Therefore, in some embodiments, the card 100 does not include a display 114.

In addition, the wireless transmitter 300 can be configured so as to transmit only when the button 116 is depressed and for a short time thereafter, e.g. 10 seconds. This feature not only extends battery life, but also reduces the number of third parties that can intercept the transmitted credit card information.

In other embodiments of the present invention, the wireless account information transmitting device 300 is not RFID, but is some other method of contactless communication, such as optical transmission, e.g. infra red (IR).

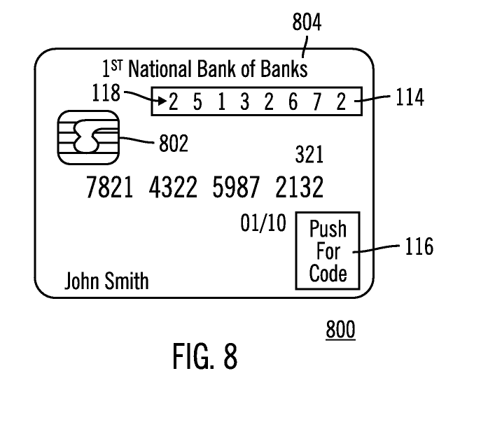

In yet another embodiment, the present invention includes a smart card, chip card, or integrated circuit(s) card (ICC). These are standard credit card sized cards with embedded integrated circuits. One such card is shown in FIG. 8. The alternative card 800 includes a small gold chip 802 about ½ inch in diameter on the front face 804 of the alternative card 800. When inserted into a reader, the chip 802 makes contact with electrical connectors that can read information from the chip and write information back. These chips take the place of magnetic strips, which are easy to duplicate, often rendered unusable by accidental introduction into a magnetic field or through normal wear and tear.

The ISO/IEC 7816 and ISO/IEC 7810 series of standards define: the physical shape, the positions and shapes of the electrical connectors, the electrical characteristics, the communications protocols, the format of the commands sent to the alternative card 800 and the responses returned by the alternative card 800, robustness of the card, and the functionality.

One embodiment of the present invention provides a contactless smart card, in which the chip 802 communicates with the card reader through RFID induction technology, as described above. The standard for contactless smart card communications is ISO/IEC 14443, dated 2001. Smart cards are able to communicate at, for example, data rates of 106 to 848 kbit/s. These cards require only close proximity to an antenna to complete a transaction.

Other outputs and signal interfaces not specifically shown in the figures, but that are well known to those of ordinary skill in the art, will work equally as well as those that are shown in FIGS. 1 and 3 and can be used in further embodiments of the present invention to achieve the same or similar results.

In yet another embodiment, the present invention includes attaching a personal identification number (PIN) to a credit card. The PIN is not displayed on the card and may or may not be stored in the card. The PIN is a number that is known to the card holder and does not change unless the card holder purposely changes it. The PIN, if given with the user's account information, can be used to authorize transactions, irregardless of the temporary access number and its current status of valid or expired. Use of the PIN is advantageous for allowing merchants to place transactions on a card holder's account at times in the future, such as for regular payments for an item or monthly memberships. These are typical situations where the card will not be physically present to generate a unique time-based code. The PIN is not wirelessly transmitted during the validation described above and the user can, therefore, maintain control over which parties have access to it.

The present invention can be implemented though a computer system that may include, inter alia, one or more computers and at least a computer readable medium allowing a computer to read data, instructions, or messages, and other computer readable information from the computer readable medium. The computer readable medium may include non-volatile memory, such as ROM, Flash memory, and other permanent storage. Additionally, a computer medium may include, for example, volatile storage such as RAM, buffers, and cache memory.

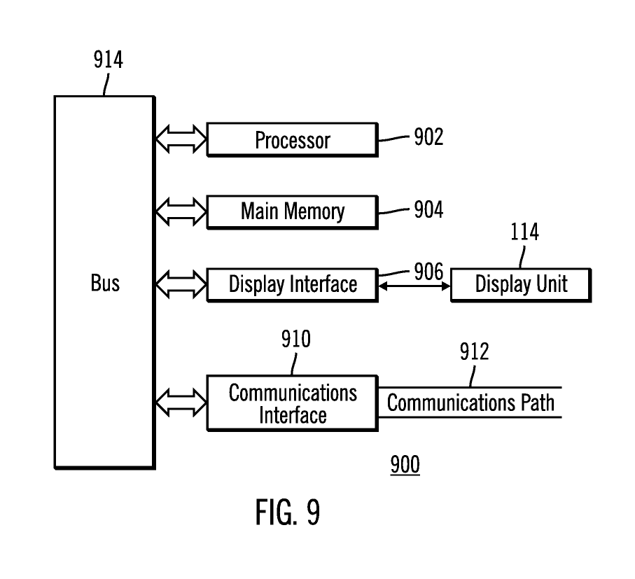

FIG. 9 is a high level block diagram illustrating a detailed view of a computing system 900 useful for implementing the number generation circuitry 306 according to embodiments of the present invention. The computing system 900 is based upon a suitably configured processing system adapted to implement an exemplary embodiment of the present invention.

In one embodiment of the present invention, the computing system 900 includes one or more processors, such as processor 902. The processor 902 is connected to a communication infrastructure 914 (e.g., a communications bus). Various software embodiments are described in terms of this exemplary computer system. After reading this description, it will become apparent to a person of ordinary skill in the relevant art(s) how to implement the invention using other computer systems and/or computer architectures.

The computing system 900 can include a display interface 906 that forwards graphics, text, and other data from the communication infrastructure 914 for display on the display unit 114. The computing system 900 also includes a memory 904, preferably random access memory (RAM), and may also include various caches and auxiliary memory as are normally found in computer systems.

The computing system 900, in this example, includes a communications interface 910 that acts as an input and output and allows software and data to be transferred. Software and data transferred via communications interface 910 are in the form of signals which may be, for example, electronic, electromagnetic, optical, or other signals capable of being received by communications interface 910. The signals are provided to communications interface 910 via a communications path (i.e., channel) 912. The channel 912 carries signals and may be implemented using wire or cable, fiber optics, a phone line, a cellular phone link, an RF link, and/or other communications channels.

Computer programs (also called computer control logic) are stored in memory 904. Computer programs may also be received via communications interface 910. Such computer programs, when executed, enable the computer system to perform the features of the present invention as discussed herein. In particular, the computer programs, when executed, enable the processor 902 to perform the features of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The terms “program”, “computer program”, “software application”, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

What is claimed is:

1. A secure economic transaction device comprising:
a memory for storing user account information;
a temporary code generator coupled to the memory and operable to generate a code based upon the user account information that is valid for only a finite amount of time; and
a wireless transmitter operable to wirelessly transmit the user account information and the code.

2. The secure economic transaction device according to claim 1, further comprising:
a medium for supporting the memory, the temporary code generator, and the wireless transmitter, wherein the medium is substantially the size and shape of a credit card.

3. The secure economic transaction device according to claim 2, wherein:
the temporary code generator is integrated within the medium.

4. The secure economic transaction device according to claim 1, wherein:
the code is based on a time of day.

5. The secure economic transaction device according to claim 1, wherein:
the code is at least partially based on a symmetric key.

6. The secure economic transaction device according to claim 1, wherein:
the wireless transmitter is one of a radio frequency identification device and an infra red transmitting device.

7. The secure economic transaction device according to claim 1, further comprising:
a wireless transceiver operable to wirelessly receive a request, wherein the wireless transceiver transmits in response to the wirelessly received request.

8. The secure economic transaction device according to claim 7, wherein:
the wireless transceiver is operable to receive a request for a new code and the temporary code generator is operable to generate a new code in response to the request for a new code and the wireless transceiver transmits the new code.

9. A method for conducting a secure economic transaction, the method comprising:
generating, with a code generator integrated within a credit-card sized medium, a code based upon a user account number that is valid at a remote account verifying entity for only a finite amount of time;
wirelessly transmitting the user account number from the medium to a payment terminal; and
wirelessly transmitting the code from the medium to the payment terminal.

10. The method according to claim 9, wherein the generating comprises:
receiving a time from a clock; and
incorporating the time into a temporary-number-generating algorithm.

11. The method according to claim 9, further comprising:
monitoring an elapsed time of a timer; and
generating a second temporary code after the elapsed time exceeds a maximum value.

12. The method according to claim 9, wherein:
the temporary code is based upon a time of day.

13. The method according to claim 9, wherein:
the temporary code is at least partially based on a symmetric key.

14. The method according to claim 9, wherein:
the wireless transmitter is one of a radio frequency identification device and an infra red transmitting device.

15. The method according to claim 9, further comprising:
communicating a personal identification number to the payment terminal.

16. A method for conducting a secure economic transaction, the method comprising:
wirelessly receiving, from a substantially credit-card sized device, a user account number and a temporary access code, the temporary access code valid for a validation time frame;
transmitting the user account number and the temporary access code to a third party for authorization of a transaction; and
receiving authorization for the transaction from the third party, the authorization based at least in part on the temporary access code being valid within the validation time frame.

17. The method according to claim 16, further comprising:
receiving a second temporary access code from the device upon the expiration of a time period.

18. The method according to claim 16, wherein:
the wireless receiving is performed by a payment terminal.

19. The method according to claim 16, wherein:
the temporary access code is generated by a temporary code generator integrated within the credit-card sized device.

20. The method according to claim 16, wherein:
the temporary code is a time-based unique code.

21. The method according to claim 16, wherein:
the temporary code is are at least partially based on a symmetric key.

22. The method according to claim 16, wherein:
the user account number and the temporary access code are received via one of a radio frequency signal and an optical signal.

23. The method according to claim 16, further comprising:
transmitting a request for at least one of the user account number and the temporary access code.

24. The method according to claim 16, further comprising:
relying a request for a new access code.
